(19) United States
(12) Patent Application Publication
(10) Pub. No.: US 2006/0184837 A1
(43) Pub. Date: Aug. 17, 2006

(54) Method, apparatus, and computer program product in a processor for balancing hardware trace collection among different hardware trace facilities

(75) Inventor: Ra'ed Mohammad Al-Omari, Cedar Park, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/056,000

(22) Filed: Feb. 11, 2005

(51) Int. Cl. G06F 11/00

(52) U.S. Cl. 714/45

(57) ABSTRACT

A method, apparatus, and computer program product are disclosed in a data processing system for balancing hardware trace collection between hardware trace facilities. A first hardware trace facility is included within a first processor. The first processor includes multiple processing units coupled together utilizing a first system bus. A second hardware trace facility is included within a second processor. The second processor includes multiple processing units coupled together utilizing a second system bus. Bus traffic is transmitted between the first and second system busses such that the first and second processors receive data transmitted on both busses. A type of trace data is specified to be captured from the first and second system busses. The first hardware trace facility captures a first subset of the specified trace data, and the second hardware trace facility captures a second subset of the specified trace data, such that the trace capture workload is balanced between the first and second hardware trace facilities.

### CROSS-REFERENCE TO RELATED APPLICATIONS

The subject matter of the present application is related to copending United States applications, Ser. No. ______ [docket AUS920040992US1], titled “Method, Apparatus, and Computer Program Product in a Processor for Performing In-Memory Tracing Using Existing Communication Paths”, Ser. No. ______ [docket AUS920040993US1], titled “Method, Apparatus, and Computer Program Product in a Processor for Concurrently Sharing a Memory Controller Among a Tracing Process and Non-Tracing Processes Using a Programmable Variable Number of Shared Memory Write Buffers”, Ser. No. ______ [docket AUS920040994US1], titled “Method, Apparatus, and Computer Program Product in a Processor for Dynamically During Runtime Allocating Memory for In-Memory Hardware Tracing”, and Ser. No. ______ [docket AUS920041000US1], titled “Method, Apparatus, and Computer Program Product for Synchronizing Triggering of Multiple Hardware Trace Facilities Using an Existing System Bus”, all filed on even date herewith, all assigned to the assignee thereof, and all incorporated herein by reference.

### BACKGROUND OF THE INVENTION

1. Technical Field

The present invention is directed to data processing systems. More specifically, the present invention is directed to a method, apparatus, and computer program product in a processor for balancing hardware trace collection among different hardware trace facilities.

2. Description of Related Art

Making tradeoffs in the design of commercial server systems has never been simple. For large commercial systems, it may take years to grow the initial system architecture draft into the system that is ultimately shipped to the customer. During the design process, hardware technology improves, software technology evolves, and customer workloads mutate. Decisions need to be constantly evaluated and reevaluated. Solid decisions need solid base data. Servers in general and commercial servers in particular place a large demand on system and operator resources, so the opportunities to collect characterization data from them are limited.

Much of performance analysis is based on hardware-collected traces. Typically, traces provide data used to simulate system performance, to make hardware design tradeoffs, to tune software, and to characterize workloads. Hardware traces are almost operating system, application, and workload independent. This attribute makes these traces especialy well suited for characterizing the On-Demand and Virtual-Server-Hosting environments now supported on the new servers.

A symmetric multiprocessing (SMP) data processing server has multiple processors with multiple cores that are symmetric such that each processor has the same processing speed and latency. An SMP system could have multiple operating systems running on different processors, which are a logically partitioned system, or multiple operating systems running on the same processors one at a time, which is a virtual server hosting environment. Operating systems divide the work into tasks that are distributed evenly among the various cores by dispatching one or more software threads of work to each processor at a time.

A single-thread (ST) data processing system includes multiple cores that can execute only one thread at a time.

A simultaneous multi-threading (SMT) data processing system includes multiple cores that can each concurrently execute more than one thread at a time per processor. An SMT system has the ability to favor one thread over another when both threads are running on the same processor.

As computer systems migrate towards the use of sophisticated multi-stage pipelines and large SMP with SMT based processors, the ability to debug, analyze, and verify the actual hardware becomes increasingly more difficult, during development, test, and during normal operations. A hardware trace facility may be used which captures various hardware signatures within a processor as trace data for analysis. This trace data may be collected from events occurring on processor cores, busses (also called the fabric), caches, or other processing units included within the processor. The purpose of the hardware trace facility is to collect hardware traces from a trace source within the processor and then store the traces in a predefined memory location.

As used herein, the term “processor” means a central processing unit (CPU) on a single chip, e.g. a chip formed using a single piece of silicon. A processor includes one or more processor cores and other processing units such as a memory controller, cache controller, and the system memory that is coupled to the memory controller.

This captured trace data may be recorded in the hardware trace facility and/or within another memory. The term “in-memory tracing” means storing the trace data in part of the system memory that is included in the processor that is being traced.

One of the traces that can be captured is a trace of the traffic on the system bus, also called the fabric. Each packet of data that is transmitted by the system bus includes identifying information in the packet. The identifying information is typically stored in an address tag in each packet. The information identifies the destination address, source address, size of the data, processor that sent the packet, the node in which the processor is located that sent the packet, and type of data included in the packet, such as whether the data is a “request” or a “response”. In addition, other identifying information may be included.

In some known systems, the fabric bus includes even cycles and odd cycles. Some processors in these systems may transmit data during only one type of cycle or during both cycles. For example, a processor A might use only the even cycles while another processor, processor B, uses only the odd cycles. Thus, one system might include three processors that transmit data during both even and odd cycles and three processors that transmit data during only the odd cycles.

According to the prior art, a time multiplexing strategy has been used to divide the fabric traffic between different tracing facility. In this strategy, when multiple hardware trace facilities are used to capture trace data, a first hardware trace facility is configured to capture traffic during only the even fabric clock cycles while a second hardware trace facility is configured to capture data during only the odd fabric clock cycles. A problem exists with the prior art systems, however, for systems such as described above where the processors do not transmit data evenly across the cycles. For a system where three processors transmit data during both even and odd cycles and three processors transmit data during only the odd cycles, the work is not balanced between the two hardware trace facilities. The hardware trace facility that is configured to capture data during only the odd fabric clock cycles must capture data transmitted by six processors while the hardware trace facility that is configured to capture data during only the even fabric clock cycles must capture data transmitted by just three processors.

Therefore, a need exists for a method, apparatus, and computer program product for balancing hardware trace collection among different hardware trace facilities.

### SUMMARY OF THE INVENTION

A method, apparatus, and computer program product are disclosed in a data processing system for balancing hardware trace collection between hardware trace facilities. A first hardware trace facility is included within a first processor. The first processor includes multiple processing units coupled together utilizing a first system bus. A second hardware trace facility is included within a second processor. The second processor includes multiple processing units coupled together utilizing a second system bus. Bus traffic is transmitted between the first and second system busses such that the first and second processors receive data transmitted on both busses. A type of trace data is specified to be captured from the first and second system busses. The first hardware trace facility captures a first subset of the specified trace data, and the second hardware trace facility captures a second subset of the specified trace data, such that the trace capture workload is balanced between the first and second hardware trace facilities.

More than two hardware trace facilities can be used. In this case, the workload can be evenly distributed throughout all hardware trace facilities.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a high level block diagram of a processor that includes the present invention in accordance with the present invention;

FIG. 2 is a block diagram of a processor core that is included within the processor of FIG. 1 in accordance with the present invention;

FIG. 3 is a block diagram of a hardware trace facility, such as a hardware trace macro (HTM), in accordance with the present invention;

FIG. 4 depicts a high level flow chart that illustrates balancing the tracing workload among multiple different hardware trace macros (HTMs) by selecting portions of the trace data to by collected by each HTM and setting filter mode bits in each HTM according to the portion of the trace data to be collected by that HTM in accordance with the present invention; and

FIG. 5 illustrates a high level flow chart that depicts a HTM filtering traffic according to the setting of filter mode bits included within the HTM in accordance with the present invention.

### DETAILED DESCRIPTION OF THE PREFERRED EMBODIMENT

A preferred embodiment of the present invention and its advantages are better understood by referring to the figures, like numerals being used for like and corresponding parts of the accompanying figures.

The present invention is a method, apparatus, and computer program product for balancing trace data collection among hardware trace facilities. A particular trace is specified. According to a preferred embodiment, this trace is a trace of the system bus, also called the fabric. A first subset of the trace is specified within the first hardware trace facility. A second subset of the trace is specified within the second hardware trace facility. The first and second subsets together can total the entire trace.

Each subset is specified within a hardware trace facility by storing information in the hardware trace facility. The hardware trace facility will snoop all of the traffic on the bus and will capture all of the traffic that includes information in its address tag that matches the information that is specified within that hardware trace facility.

For example, a particular hardware trace facility can be configured to capture trace data from a particular processor by storing information in a register in the hardware trace facility that identifies the particular processor. For example, each processor and node includes a unique identifier. A particular processor or node can be identified by storing that particular processor or node's unique identifier in the hardware trace facility.

The hardware trace facility can be configured to capture trace data from all of the processors that are included within a particular node by storing the unique identifier of the particular node in the hardware trace facility.

The hardware trace facility can be configured to capture trace all data that is transmitted via the system bus that is a particular type of event. Each data packet will include an event type that identifies the type of event transmitted in the packet. For example, the hardware trace facility can be configured to capture all “request” type events.

The hardware trace facility can be configured to capture trace data from a particular combination of selected processor(s), node(s), and/or event type(s). For example, the hardware trace facility can be configured to capture all request events that are transmitted from processor A that is located in node B. In order to capture this particular combination, the unique identifier that identifies processor A, the unique identifier that identifies node B, and an identifier that identifies “requests” are all stored in the hardware trace facility. In order to be captured by this hardware trace facility, the bus traffic include a type that is a “request”, a processor ID that identifies processor A, and a node ID that identifies node B in its address tag.

As another example, the hardware trace facility can be configured to capture all data transmitted from processors A and B in node A and processor A in node B.

The HTM includes registers in which can be stored information that identifies a selected subset of data. The one or more identifiers that identify the selected subset are stored in the registers. Thus, a processor ID, a node ID, and/or a request type can be stored in these registers. When the HTM snoops bus traffic, the HTM filters the traffic using the information that is currently stored in the HTM's registers. If the snooped traffic includes information in its address tag that matches the information that is stored in the HTM's registers, the snooped traffic is captured by the HTM as trace data. If the snooped traffic does not include information in its address tag that matches the information that is stored in the HTM's registers, the snooped traffic is not captured by the HTM.

The subset of bus traffic that is selected to be captured by a particular HTM can be selected in order to balance the tracing workload of the HTM with another one or more HTMs. For example, in a system that includes two HTMs, one HTM can be configured to capture half of the total trace data while the other HTM is configured to capture the other half of the total trace data.

The following is a description of the tracing process executed by the present invention. According to the present invention, a control routine sends a notice to a hypervisor that is included within the data processing system telling the hypervisor to enable the HTM for tracing. The control routine also indicates a specified size of memory to request to be allocated to the HTM.

The hypervisor then enables the HTM for tracing by setting the trace enable bit within the HTM. The hypervisor stores the size of memory to request to be allocated in the address register in the HTM.

When the trace enable bit is set, the HTM then requests the hypervisor, also referred to herein as firmware, to allocate the particular size of memory that is specified in its address register. The hypervisor then dynamically allocates memory by selecting locations within its system memory. These selected locations are then marked as “defective”. The contents of these registers are copied to a new location before trace data is stored in the selected locations. The processes, other than the HTM, that access these locations are then redirected to the new locations.

The hypervisor then notifies the HTM that the memory has been allocated by setting a “mem_alloc_done” bit in the HTM in a memory control register that is included with the SCOM stage. The HTM then stores trace data in the allocated memory.

The allocated memory can be deallocated during runtime once the HTM finishes tracing.

The HTM looks like any other processing unit in the processor to the fabric. It uses the same data and addressing scheme, protocols, and coherency used by the other processing units in the processor. Therefore, there is no need for extra wiring or side band signals. There is no need for a special environment for verification since it will be verified with the standard existing verification functions.

The HTM captures hardware trace data in the processor and transmits it to a system memory utilizing a system bus. The system bus, referred to herein as the fabric and/or fabric bus controller and bus, is capable of being utilized by processing units included in the processor while the hardware trace data is being transmitted to the system bus. A standard bus protocol is used by these processing units to communication with each other via the standard existing system bus.

According to the present invention, the hardware trace facility, i.e. the HTM, is coupled directly to the system bus. The memory controllers are also coupled directly to the system bus. The HTM uses this standard existing system bus to communicate with a particular memory controller in order to cause the memory controller to store hardware trace data in the system memory that is controlled by that memory controller.

The HTM transmits its hardware trace data using the system bus. The hardware trace data is formatted according to the standard bus protocol used by the system bus and the other processing units. The hardware trace data is then put out on the bus in the same manner and format used for to transmit all other information.

The memory controller(s) snoop the bus according to prior art methods.

According to the present invention, when trace data is destined for a particular memory controller, the trace data is put on the bus as bus traffic that is formatted according to the standard bus protocol. The particular memory controller is identified in this bus traffic. The memory controller will then retrieve the trace data from the bus and cause the trace data to be stored in the memory controlled by this memory controller.

In a preferred embodiment, a data processing system includes multiple nodes. Each node includes four separate processors. Each processor includes two processing cores and multiple processing units that are coupled together using a system bus. The system busses of each processor in each node are coupled together. In this manner, the processors in the various nodes can communicate with processors in other nodes via their system busses following the standard bus protocol.

One or more memory controllers are included in each processor. The memory controller that is identified by the bus traffic can be any memory controller in the system. Each memory controller controls a particular system memory. Because the standard system bus and bus protocol are used by the HTM, the trace data does not need to be stored in the system memory in the processor which includes the HTM that captured trace data. The trace data can instead be stored in a system memory in another processor in this node or in any other node by identifying, in the bus traffic, a memory controller in another processor in this node or a memory controller in a different node.

Prior to starting a trace, the HTM will be configured to capture a particular trace. The HTM will first request that system memory be allocated to the HTM for storing the trace data it is about to collect. This memory is then allocated to the HTM for its exclusive use. The memory may be located in any system memory in the data processing system regardless of in which processor the trace data is originating.

According to the present invention, the memory controller is connected directly to the fabric bus controller. The memory controller is not coupled to the fabric bus controller through a multiplexer.

The trace facility, i.e. the hardware trace macro (HTM), is coupled directly to the fabric bus controller as if it were any other type of storage unit, e.g. an L3 cache controller, an L2 cache controller, or a non-cacheable unit. The HTM uses cast out requests to communicate with the memory controllers. A cast out request is a standard type of request that is used by the other processing units of the processor to store data in the memory. Processing units in one processor can cast out data to the system memory in that processor on to memory in other processors in this node or other processors in other nodes.

These cast out requests consist of two phases, address and data requests. These cast out requests are sent to the fabric bus controller which places them on the bus. All of the processing units that are coupled directly to the bus snoop the bus for address requests that should be processed by that processing unit. Thus, the processing units analyze each address request to determine if that processing unit is to process the request. For example, an address request may be a request for the allocation of a write buffer to write to a particular memory location. In this example, each memory controller will snoop the request and determine if it controls the system memory that includes the particular memory location. The memory controller that controls the system memory that includes the particular memory location will then get the cast out request and process it.

A cast out data request is used by the HTM to notify the fabric bus controller that the HTM trace buffer has trace data to be copied. The fabric bus controller then needs to copy the data. The fabric bus controller will use a tag, from the Dtag buffer, that includes an identification of a particular memory controller and a write buffer. The fabric bus controller then copies the data to the specific memory controller write buffer, which is identify by the tag.

Because the HTM uses cast out requests to communicate with the memory controllers, any memory controller, and thus any system memory, can be used for storing trace data. The fabric bus controller/bus transmits requests to the processing units in the processor that controls the HTM and also transmits requests to other processors in the same node as this processor and to other nodes as well. Therefore, a system memory in this processor, in another processor in this node, or in a processor in another node, can be used for storing trace data from this HTM.

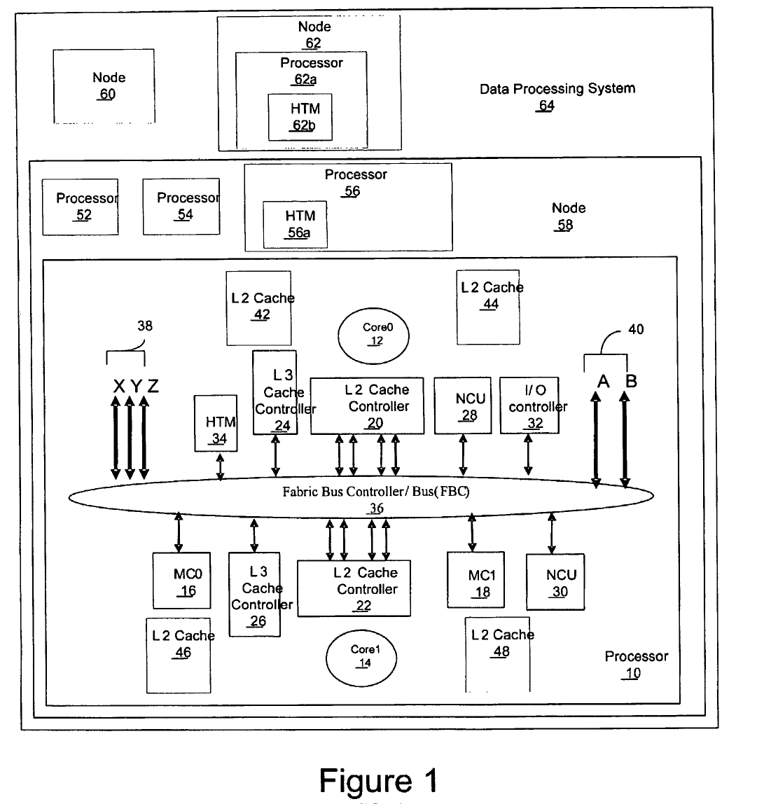

FIG. 1 is a high level block diagram of a processor 10 that includes the present invention in accordance with the present invention. Processor 10 is a single integrated circuit chip. Processor 10 includes multiple processing units such as two processor cores, core 12 and core 14, a memory controller 16, a memory controller 18, an L2 cache controller 20, an L2 cache controller 22, an L3 cache controller 24, four quarters 42, 44, 46, and 48 of an L2 cache, an L3 cache controller 26, a non-cacheable unit (NCU) 28, a non-cacheable unit (NCU) 30, an I/O controller 32, a hardware trace macro (HTM) 34, and a fabric bus controller and bus 36. Communications links 38 are made to other processors, e.g. processor 52, 54, 56, inside the node, i.e. node 58, that includes processor 10. Communications links 40 are made to other processors in other nodes, such as nodes 60 and 62.

According to the preferred embodiment of the present invention, each processor will include its own hardware trace macro. For example, as depicted by FIG. 1, processor 56 includes HTM 56a. Node 62 includes processor 62a which includes HTM 62b.

Each processor, such as processor 10, includes two cores, e.g. cores 12, 14. A node is a group of four processors. For example, processor 10, processor 52, processor 54, and processor 56 are all part of node 58. There are typically multiple nodes in a data processing system. For example, node 58, node 60, and node 62 are all included in data processing system 64. Thus, communications links 38 are used to communicate among processors 10, 52, 54, and 56. Communications links 40 are used to communicate among processors in nodes 58, 60, and 62.

Although connections are not depicted in FIG. 1, each core 12 and 14 is coupled to and can communicate with the other core and each processing unit depicted in FIG. 1 including memory controller 16, memory controller 18, L2 cache controller 20, L2 cache controller 22, L3 cache controller 24, L3 cache 26, non-cacheable unit (NCU) 28, non-cacheable unit (NCU) 30, I/O controller 32, hardware trace macro (HTM) 34, and fabric bus controller and bus 36. Each core 12 and 14 can also utilize communications links 38 and 40 to communicate with other cores and devices. Although connections are not depicted, L2 cache controllers 20 and 22 can communicate with L2 cache quarters 42, 44, 46, and 48.

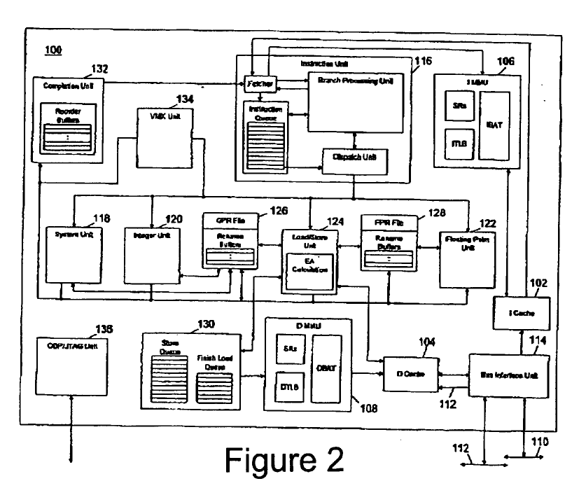

FIG. 2 depicts a block diagram of a processor core in which a preferred embodiment of the present invention may be implemented are depicted. Processor core 100 is included within processor/CPU chip 10 that is a single integrated circuit superscalar microprocessor (CPU), such as the PowerPC™ processor available from IBM Corporation of Armonk, N.Y. Accordingly, processor core 100 includes various processing units both specialized and general, registers, buffers, memories, and other sections, all of which are formed by integrated circuitry.

Processor core 100 includes level one (L1) instruction and data caches (I Cache and D Cache) 102 and 104, respectively, each having an associated memory management unit (I MMU and D MMU) 106 and 108. As shown in FIG. 2, processor core 100 is connected to system address bus 110 and to system data bus 112 via bus interface unit 114. Instructions are retrieved from system memory (not shown) to processor core 100 through bus interface unit 114 and are stored in instruction cache 102, while data retrieved through bus interface unit 114 is stored in data cache 104. Instructions are fetched as needed from instruction cache 102 by instruction unit 116, which includes instruction fetch logic, instruction branch prediction logic, an instruction queue, and a dispatch unit.

The dispatch unit within instruction unit 116 dispatches instructions as appropriate to execution units such as system unit 118, integer unit 120, floating point unit 122, or load/store unit 124. System unit 118 executes condition register logical, special register transfer, and other system instructions. Integer or fixed-point unit 120 performs add, subtract, multiply, divide, shift or rotate operations on integers, retrieving operands from and storing results in integer or general purpose registers (GPR File) 126. Floating point unit 122 performs single precision and/or double precision multiply/add operations, retrieving operands from and storing results in floating point registers (FPR File) 128. VMX unit 134 performs byte reordering, packing, unpacking, and shifting, vector add, multiply, average, and compare, and other operations commonly required for multimedia applications.

Load/store unit 124 loads instruction operands from data caches 104 into integer registers 126, floating point registers 128, or VMX unit 134 as needed, and stores instructions results when available from integer registers 126, floating point registers 128, or VMX unit 134 into data cache 104. Load and store queues 130 are utilized for these transfers from data cache 104 to and from integer registers 126, floating point registers 128, or VMX unit 134. Completion unit 132, which includes reorder buffers, operates in conjunction with instruction unit 116 to support out-of-order instruction processing, and also operates in connection with rename buffers within integer and floating point registers 126 and 128 to avoid conflict for a specific register for instruction results. Common on-chip processor (COP) and joint test action group (JTAG) unit 136 provides a serial interface to the system for performing boundary scan interconnect tests.

The architecture depicted in FIG. 2 is provided solely for the purpose of illustrating and explaining the present invention, and is not meant to imply any architectural limitations. Those skilled in the art will recognize that many variations are possible. Processor core 100 may include, for example, multiple integer and floating point execution units to increase processing throughput. All such variations are within the spirit and scope of the present invention.

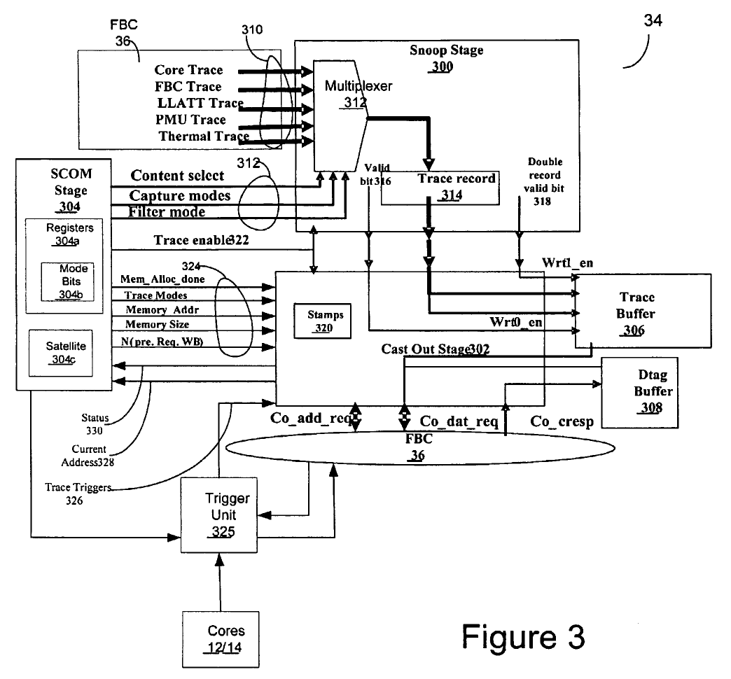

FIG. 3 is a block diagram of a hardware trace macro (HTM) 34 in accordance with the present invention. HTM 34 includes a snoop stage 300, a trace cast out stage 302, and an SCOM stage 304. HTM 34 also includes an internal trace buffer 306 and a Dtag buffer 308.

Snoop stage 300 is used for collecting raw traces from different sources and then formatting the traces into multiple 128-bit frames. Each frame has a record valid bit and double record valid bit. The double record valid bit is used to identify if both the upper halves, e.g. bits 0-63, and the lower halves, e.g. bits 64-127, of the trace record are valid. If both bits, valid and double valid bits, are set to “1”, both halves are valid. If the double valid bit is set to “0”, only the upper half, i.e. bits 0-63, is valid. If both are set to “0” then none of the halves has valid data.

Snoop stage 300 snoops the traffic on fabric 36. Snoop stage 300 retrieves trace data from fabric 36 according to the filter and mode settings in HTM 34.

The trace data inputs to snoop stage 300 are the five hardware trace sources 310, select trace mode bits, capture mode bit, and filter mode bits 312. The outputs from this stage are connected to cast out stage 302. The outputs are a 128-bit trace record 314, a valid bit 316, and a double record valid bit 318.

There are five hardware trace sources: a core trace, a fabric trace, i.e. FBC trace, an LLATT trace, a PMU trace, and a thermal trace.

The core trace is an instruction trace for code streams that are running on a particular core.

The FBC trace is a fabric trace and includes all valid events, e.g. requests and responses, that occur on the fabric bus.

The LLATT trace is a trace from an L2 cache that is included within a processor. The LLATT trace includes load and store misses of the L1 cache generated by instruction streams running on a particular core.

The PMU trace is a performance monitor trace. It includes traces of events from the L3 cache, each memory controller, the fabric bus controller, and I/O controller.

The thermal trace includes thermal monitor debug bus data.

Trace cast out stage 302 is used for storing the trace record received from snoop stage 300 to one of the system memories or to another system memory in another processor that is either in this or another node. Trace cast out stage 302 is also responsible for inserting the proper stamps 320 into the trace data and managing trace buffer 306. Trace cast out stage 302 includes interfaces to fabric bus controller/bus 36, snoop stage 300, trace buffer 306, Dtag buffer 308, trace triggers, operation modes and memory allocation bits, and status bits.

Multiple different types of stamps are generated by stamps 320. A start stamp is created in the trace buffer whenever there is a transition from a paused state to a tracing state. This transition is detected using the start trace trigger.

When the HTM is enabled and in the run state, a mark stamp will be inserted into the trace data when a mark trigger occurs.

A freeze stamp is created and inserted into the trace data whenever the HTM receives a freeze trace trigger.

Time stamps are generated and inserted in the trace data when certain conditions occur. For example, when valid data appears after one or more idle cycles, a time stamp is created and inserted in the trace data.

SCOM stage 304 has an SCOM satellite 304c and SCOM registers 304a. SCOM satellite 304c is used for addressing the particular SCOM register. SCOM registers 304c include an HTM collection modes register, a trace memory configuration mode register, an HTM status register, and an HTM freeze address register. SCOM registers also includes mode bits 304b in which the various filter and capture modes are set.

Cast out stage 302 receives instructions for starting/stopping from processor cores 12, 14, SCOM stage 304, or global triggers through the fabric 36. SCOM stage 304 receives instructions that describe all of the information that is needed in order to perform a trace. This information includes an identification of which trace to receive, a memory address, a memory size, the number of write buffers that need to be requested, and a trace mode. This information is stored in registers 304a and mode bits 304b. This information is then provided to snoop stage 300 in order to set snoop stage 300 to collect the appropriate trace data from fabric 36.

SCOM stage 304 generates a trace enable signal 322 and signals 324.

Trace triggers 326 include a start trigger, stop trigger, pause trigger, reset trigger, freeze trigger, and an insert mark trigger. The start trigger is used for starting a trace. The stop trigger is used for stopping a trace. The pause trigger is used to pause trace collection. The reset trigger is used to reset the frozen state and reset to the top of trace buffer 306. The freeze trigger is used to freeze trace collection. The HTM will ignore all subsequent start or stop triggers while it is in a freeze state. The freeze trigger causes a freeze stamp to be inserted into the trace data. The insert mark trigger is used to insert a mark stamp into the trace data.

Trace triggers 326 originate from a trigger unit 325. Trigger unit 325 receives trigger signals from fabric 36, one of the cores 12, 14, or SCOM stage 304.

Signals 324 include a memory allocation done (mem_alloc_done) signal, trace modes signal, memory address signal, memory size signal, and a signal “N” which is the number of pre-requested write buffers.

According to the present invention, a configurable sequential address range, controlled by one or more of the memory controllers, is configured to be allocated to the trace function. This range can be statically assigned during the initial program load (IPL) or dynamically using software. Software will support allocation and relocation of physical memory on a system that has booted and is executing.

The process of allocation and relocation includes having the firmware declare a particular memory region as “defective” and then copying the current contents of the region to a new location. The contents of the region continue to be available to the system from this new location. This particular memory region is now effectively removed from the system memory and will not be used by other processes executing on the system. This particular memory region is now available to be allocated to the hardware trace macro for its exclusive use for storing hardware trace data.

To define this memory, the software that controls the HTM will write to an SCOM register using calls to the hypervisor. This SCOM register has a field that is used to define the base address and the size of the requested memory. The HTM will then wait until a Mem_Alloc_Done signal is received before it starts using the memory.

After enabling the HTM and allocating system memory in which to store trace data, the HTM will start the process of collecting trace data by selecting one of its inputs, i.e. inputs 310, to be captured. The trace routine that is controlling the HTM will define the memory beginning address, the memory size, and the maximum number of write buffers that the HTM is allowed to request before it has trace data to store.

To initiate the write buffer allocation process, the HTM will serially drive a series of cast out requests to the fabric controller bus, one for each number of write buffers that are allowed. If no write buffers are pre-allocated, the HTM will send a cast out request each time it has accumulated a cache line of data. A cache line of data is preferably 128 bytes of data.

The HTM will keep a count of the number of write buffers currently allocated to the HTM. Upon receiving a response from the fabric bus controller that a write buffer has been allocated to the HTM, the HTM will increment the count of the number of allocated buffers. This response will include routing information that identifies the particular memory controller that allocated the write buffer and the particular write buffer allocated. The HTM will save the routing information received from the fabric bus controller as a tag in Dtag buffer 308. This information will be used when the HTM generates a cast out data request that indicates that the HTM has trace data in trace buffer 306 that is ready to be stored in the system memory. If the response from the fabric bus controller indicates that a write buffer was not allocated, the HTM will retry its request.

When the HTM receives a start trace trigger, the HTM will begin collecting the trace that is selected using signals 312. Multiplexer 312 is controlled by signals 312 to select the desired trace. The trace data is then received in trace record 314 and then forwarded to trace buffer 306. At the start of the trace, prior to saving any trace data, a start stamp from stamps 320 is saved in trace buffer 306 to indicate the start of a trace.

When the HTM has collected 128 bytes of data, including trace data and any stamps that are stored, the HTM will send a cast out data request signal to the fabric bus controller if there is at least one write buffer allocated to the HTM. Otherwise, the HTM will request the allocation of a write buffer, wait for that allocation, and then send the cast out data request. Trace buffer 306 is capable of holding up to four cache lines of 128 bytes each. Once trace buffer 306 is full, it will start dropping these trace records. An 8-bit counter increments for every dropped record during this period of time that the buffer is full. If the 8-bit counter overflows, a bit is set and the counter rolls over and continues to count. When the buffer frees up, a timestamp entry is written before the next valid entry is written.

The fabric bus controller will then copy the data out of trace buffer 306 and store it in the designated write buffer. The HTM will then decrement the number of allocated write buffers.

When the HTM receives a stop trace trigger, the HTM will stop tracing.

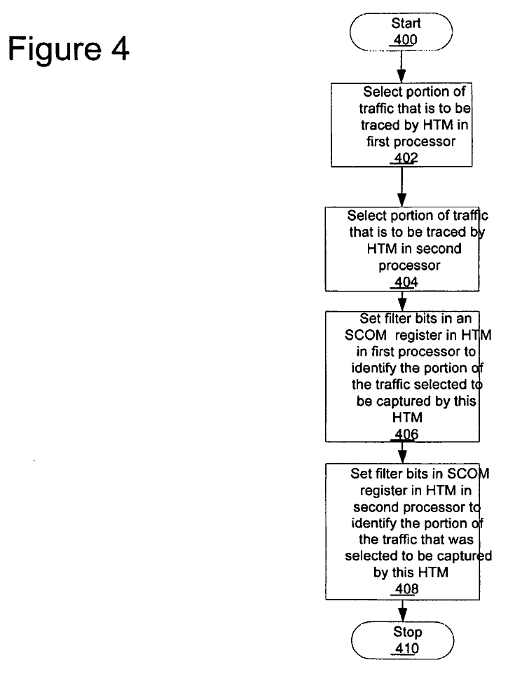

FIG. 4 depicts a high level flow chart that illustrates balancing the tracing workload among multiple different hardware trace macros (HTMs) by selecting portions of the trace data to by collected by each HTM and setting filter mode bits in each HTM according to the portion of the trace data to be collected by that HTM in accordance with the present invention. The process starts as depicted by block 400 and thereafter passes to block 402 which illustrates selecting a portion of the traffic that is to be traced by the HTM that is included in the first processor. Next, block 404 depicts selecting a portion of the traffic that is to be traced by the HTM that is included in the second processor.

The process then passes to block 406 which illustrates setting the filter bits in the SCOM in the HTM in the first processor to identify the portion of the traffic that was selected to be captured by this HTM. Thereafter, block 408 depicts setting the filter bits in the SCOM in the HTM in the second processor to identify the portion of the traffic that was selected to be captured by this HTM. The process then terminates as illustrated by block 410.

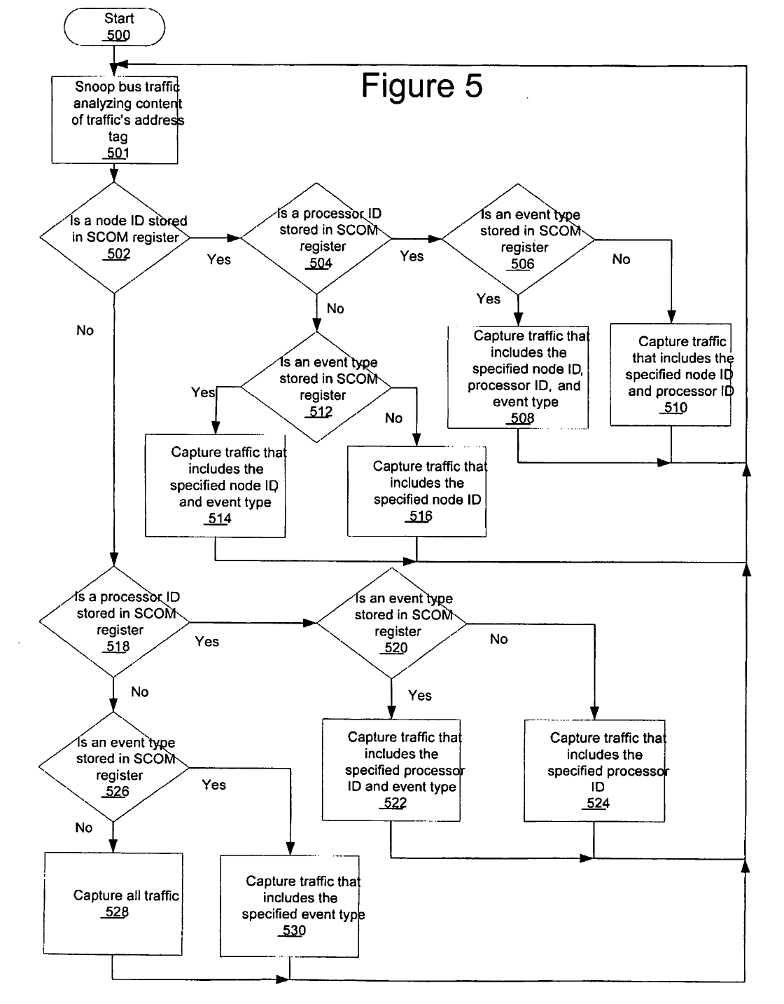

FIG. 5 illustrates a high level flow chart that depicts an HTM filtering traffic according to the setting of filter mode bits included within the HTM in accordance with the present invention. The process starts as depicted by block 500 and thereafter passes to block 501 which illustrates snooping bus traffic and analyzing the content of the traffic's address tag. Next, block 502 depicts a determination of whether or not there is a node ID stored in the SCOM register of this HTM. If a determination is made that there is a node ID stored in the SCOM register, the process passes to block 504 which depicts a determination of whether or not there is a processor ID stored in the SCOM register. If a determination is made that there is a processor ID stored in the SCOM register, the process passes to block 506 which illustrates a determination of whether or not there is an event type stored in the SCOM register. If a determination is made that there is an event type stored in the SCOM register, the process passes to block 508 which depicts this HTM capturing traffic that includes the node ID, processor ID, and event type that are specified within registers in this HTM's SCOM. The process then passes back to block 501.

Referring again to block 506, if a determination is made that there is not an event type stored in the SCOM register, the process passes to block 510 which depicts this HTM capturing traffic that includes the node ID and processor ID that are specified within registers in this HTM's SCOM. The process then passes back to block 501.

Referring again to block 504, if a determination is made that there is not a processor ID stored in the SCOM register, the process passes to block 512 which depicts a determination of whether or not there is an event type stored in the SCOM register. If a determination is made that there is an event type stored in the SCOM register, the process passes to block 514 which depicts this HTM capturing traffic that includes the node ID and event type that are specified within registers in this HTM's SCOM. The process then passes back to block 501.

Referring again to block 512, if a determination is made that there is not an event type stored in the SCOM register, the process passes to block 516 which depicts this HTM capturing traffic that includes the node ID that is specified within registers in this HTM's SCOM. The process then passes back to block 501.

Referring again to block 502, if a determination is made that there is not a node ID stored in the SCOM register, the process passes to block 518 which depicts a determination of whether or not there is a processor ID stored in the SCOM register. If a determination is made that there is a processor ID stored in the SCOM register, the process passes to block 520 which depicts a determination of whether or not there is an event type stored in the SCOM register. If a determination is made that there is an event type stored in the SCOM register, the process passes to block 522 which depicts this HTM capturing traffic that includes the processor ID and event type that are specified within registers in this HTM's SCOM. The process then passes back to block 501.

Referring again to block 520, if a determination is made that there is not an event type stored in the SCOM register, the process passes to block 524 which depicts this HTM capturing traffic that includes the processor ID that is specified within registers in this HTM's SCOM. The process then passes back to block 501.

Referring again to block 518, if a determination is made that there is not a processor ID stored in the SCOM register, the process passes to block 526 which depicts a determination of whether or not there is an event type stored in the SCOM register. If a determination is made that there is not an event type stored in the SCOM register, the process passes to block 528 which depicts this HTM capturing all traffic. The process then passes back to block 501.

Referring again to block 526, if a determination is made that there is an event type stored in the SCOM register, the process passes to block 530 which depicts this HTM capturing traffic that includes the event type that is specified within registers in this HTM's SCOM. The process then passes back to block 501.

It is important to note that while the present invention has been described in the context of a fully functioning data processing system. Those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for balancing hardware trace collection between hardware trace facilities, said method comprising:
including a first hardware trace facility within a first processor, said first processor including a first plurality of processing units coupled together utilizing a first system bus;
including a second hardware trace facility within a second processor, said second processor including a second plurality of processing units coupled together utilizing a second system bus;
transmitting bus traffic between said first and said second system busses, wherein said first and second processors receive data transmitted on said first and second system busses;
specifying a particular trace to be captured from said first and second system busses; and
balancing capturing of said particular trace between said first and second hardware trace facilities using information that is included in said bus traffic.

2. The method according to claim 1, further comprising:
dividing said trace into a first subset and a second subset;
specifying, within said first hardware trace facility, said first subset of said trace by specifying first information;
specifying, within said second hardware trace facility, said second subset of said trace by specifying second information;
capturing, by said first hardware trace facility, only traffic that includes said first information; and
capturing, by said second hardware trace facility, only traffic that includes said second information.

3. The method according to claim 2, further comprising:
traffic that includes said first information being a first half of said trace and traffic that includes said second information being a second half of said trace.

4. The method according to claim 3, further comprising:
snooping, by said first and second hardware trace facilities, traffic on said first and second system busses;
determining, by said first hardware trace facility, whether said snooped traffic includes said first information;
in response to determining by said first hardware trace facility that said snooped traffic includes said first information, capturing, by said first hardware trace facility, said snooped traffic;
determining, by said second hardware trace facility, whether said snooped traffic includes said second information; and
in response to determining by said second hardware trace facility that said snooped traffic includes said second information, capturing, by said second hardware trace facility, said snooped traffic.

5. The method according to claim 3, further comprising:
traffic including said first information being all traffic transmitted by said first processor.

6. The method according to claim 3, further comprising:
traffic including said first information being all traffic transmitted by said second processor.

7. The method according to claim 3, further comprising:
traffic including said first information being all traffic transmitted by said first and second processors.

8. The method according to claim 3, further comprising:
traffic including said first information being all traffic that is a particular type of event.

9. The method according to claim 8, further comprising:
traffic including said first information being all requests.

10. The method according to claim 8, further comprising:
traffic including said first information being all responses.

11. The method according to claim 3, further comprising:
said first and second processors being included within a first node;
said data processing system including said first node and a second node that includes a third processor;
selecting a particular node; and
traffic including said first information being all traffic transmitted by processors in said selected particular node.

12. The method according to claim 3, further comprising:
traffic including said first information being all traffic transmitted by a particular combination of a particular node, a particular processor, and a particular type of event.

13. An apparatus in a data processing system for balancing hardware trace collection between hardware trace facilities, said apparatus comprising:
a first hardware trace facility included within a first processor, said first processor including a first plurality of processing units coupled together utilizing a first system bus;
a second hardware trace facility included within a second processor, said second processor including a second plurality of processing units coupled together utilizing a second system bus;
said bus traffic being transmitted between said first and said second system busses, wherein said first and second processors receive data transmitted on said first and second system busses;
a particular trace specified to be captured from said first and second system busses; and
information that is included in said bus traffic used to balance capturing of said particular trace between said first and second hardware trace facilities.

14. The apparatus according to claim 13, further comprising:
said trace divided into a first subset and a second subset;
said first hardware trace facility for specifying said first subset of said trace by specifying first information;
said second hardware trace facility for specifying said second subset of said trace by specifying second information;
said first hardware trace facility for capturing only traffic that includes said first information; and
said second hardware trace facility for capturing only traffic that includes said second information.

15. The apparatus according to claim 14, further comprising:
traffic that includes said first information being a first half of said trace and traffic that includes said second information being a second half of said trace.

16. The apparatus according to claim 15, further comprising:
said first and second hardware trace facilities snooping traffic on said first and second system busses;
said first hardware trace facility determining whether said snooped traffic includes said first information;
in response to determining by said first hardware trace facility that said snooped traffic includes said first information, said first hardware trace facility capturing said snooped traffic;
said second hardware trace facility for determining whether said snooped traffic includes said second information; and
in response to determining by said second hardware trace facility that said snooped traffic includes said second information, said second hardware trace facility capturing said snooped traffic.

17. The apparatus according to claim 15, further comprising:
traffic including said first information being all traffic transmitted by said first processor.

18. The apparatus according to claim 15, further comprising:
traffic including said first information being all traffic that is a particular type of event.

19. The apparatus according to claim 15, further comprising:
traffic including said first information being all traffic transmitted by a particular combination of a particular node, a particular processor, and a particular type of event.

20. A computer program product for balancing hardware trace collection between hardware trace facilities in a data processing system, said product comprising:
including a first hardware trace facility within a first processor, said first processor including a first plurality of processing units coupled together utilizing a first system bus;
including a second hardware trace facility within a second processor, said second processor including a second plurality of processing units coupled together utilizing a second system bus;
instructions for transmitting bus traffic between said first and said second system busses, wherein said first and second processors receive data transmitted on said first and second system busses;
instructions for specifying a particular trace to be captured from said first and second system busses; and
instructions for balancing capturing of said particular trace between said first and second hardware trace facilities using information that is included in said bus traffic.
